(19) United States
(12) Patent Application Publication
(10) Pub. No.: US 2005/0080807 A1
(43) Pub. Date: Apr. 14, 2005

(54) Extensible creation and editing of integrated collections

(75) Inventors: Craig Beilinson, Bellevue, WA (US); Christopher A. Evans, Sammamish, WA (US); David Winkler, Seattle, WA (US); Jae Park, Redmond, WA (US); Emily Buchanan, Seattle, WA (US); Jared Henderson, Maple Valley, WA (US); Jeffrey Belt, Bellevue, WA (US); Pritvinath Obla, Kirkland, WA (US); Anthony Chor, Bellevue, WA (US); William Gould, Seattle, WA (US); Shabbir Shahpurwala, Sammamish, WA (US); Relja Ivanovic, Redmond, WA (US)

Correspondence Address: BANNER & WITCOFF LTD.,;ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/684,263

(22) Filed: Oct. 12, 2003

(51) Int. Cl. G06F 17/00; G06F 17/30

(52) U.S. Cl. 707/102; 707/7; 707/104.1

(57) ABSTRACT

A tool for creating integrated collections. The tool may include a “basket” control that includes interfaces for receiving and displaying the data objects that are selected by a user to be included in a collection, and a collection creation component then provides a collection with one or more data items corresponding to the objects submitted to the basket control. The basket control may be employed by itself to make collections, or it may be hosted by another software object, such as a “listmaker” control that conveniently contains both the basket control and one or more user interfaces that a user can employ to provide data objects to the basket control. The listmaker control may thus include a viewing graphical user interface for viewing data objects and a navigation toolbar for navigating the viewing graphical user interface. The listmaker control may then be hosted as desired in a variety of software applications.

### FIELD OF THE INVENTION

The present invention relates to the creation and editing of integrated collections. Various aspects of the present invention are particularly applicable to providing a tool for creating or editing a collection of data objects, so that the objects can be manipulated as an integrated unit.

### BACKGROUND OF THE INVENTION

As computers have become more and more ubiquitous in our culture, people from all walks of life have grown accustomed to using computers for a variety of tasks. For example, a high school student might use a personal computer to copy a group of music files to a digital music player, while a grandparent may employ a personal computer to send files of photographic images to a granddaughter or grandson. A business executive might then use a corporate computer networked to a central server to send and receive business application files, such as Microsoft Word and Microsoft Excel files, by an electronic mail messaging service like Microsoft Outlook.

While the uses of computers have grown in diversity and sophistication, the tools provided by computers for manipulating data need to become more diverse and sophisticated as well. In particular, while many users would like to be able to perform the same operation on multiple data files, most computers do not provide a convenient technique for creating a collection of data files to be manipulated simultaneously.

Some operating systems, for example, will allow a user to select multiple files for simultaneous manipulation (by, e.g., concurrently pressing the “control” key while selecting each file with a pointing device). Once the files have been selected, however, no action can be taken regarding a non-selected data file without destroying the grouping of the selected files. Also, all of the files must typically be selected from a single location, such as from within the same folder, and cannot be selected from separate locations.

Additionally, various specialized software applications may allow a user to group files into a collection for specific purposes. For example, a software application for playing music data files may allow a user to group music files into a playlist. These applications typically limit the user's manipulations of the group of files, however, to functions related to the software application. Moreover, a grouping feature provided by such a specialized software application typically cannot be used outside of the software application.

### BRIEF SUMMARY OF THE INVENTION

It therefore would be useful to have an architecture for creating and editing integrated collections of data objects, so that the data objects can be manipulated as an integrated unit. Moreover, it would be useful to have such a collection-creating architecture that is extensible across multiple software applications and platforms.

Advantageously, various examples of the invention provide a tool for creating integrated collections. With some implementations of the invention, the tool may include a “basket” control that receives objects to be included in a collection. The basket control may, for example, include interfaces for receiving and displaying the data objects that are selected by a user to be included in a collection. A user may thus build a collection of data objects simply by providing the data objects to the basket control. A collection creation component then provides a collection with one or more data items corresponding to the objects submitted to the basket control. With various aspects of the invention, a collection can be compiled with any desired data objects, including discrete data (such as text), data files, queries or exclusions for identifying data files based upon designated criteria, both virtual and physical folders containing one or more data objects, and even other collections of data objects.

The basket control may be employed by itself to make collections, or it may be hosted by another software object. For example, various implementations of the invention may additionally include a “listmaker” control that conveniently contains both the basket control and one or more user interfaces that a user can employ to provide data objects to the basket control. For example, the listmaker control may include a viewing graphical user interface (such as a file browser) for viewing data objects and a navigation toolbar for navigating the viewing graphical user interface. The listmaker control may then be hosted as desired by software developers in a variety of software applications.

### BRIEF DESCRIPTION OF THE DRAWINGS

FIG. 1 shows an example of a computing environment in which various embodiments of the invention may be implemented.

FIG. 2 shows an example of a basket control according to various embodiments of the invention.

FIG. 3 shows a toolbar including navigational controls for navigating the basket control according to various embodiments of the inventions.

FIG. 4 shows a dialog box for creating a new collection of data objects according to various embodiments of the invention.

FIG. 5 shows an example of a listmaker control according to various embodiments of the invention.

### DETAILED DESCRIPTION OF THE INVENTION

Overview

Various implementations of the invention provide a tool for creating or editing integrated collections of data objects. The collections may include many different types of data objects, such as discrete portions of text, data files, queries or exclusions for identifying data files based upon designated criteria, both virtual and physical folders containing one or more data objects, and even other collections of data objects. Once a collection is created, all data objects in the collection can be simultaneously manipulated as an integrated unit.

Advantageously, various implementations of a tool according to the invention may be extended by software developers over a variety of software applications and platforms. For example, one or more implementations of the tool may be incorporated by a software developer into a software application, in order to allow a user of the application to make collections for the software application.

The tool may provide a “basket” control. Using this type of control, a user may create collections of data objects simply by submitting the desired objects to the control. For example, the basket control may be employed with an operating system that uses a graphical user interface for receiving data objects. With this arrangement, a user may submit data objects to the basket control simply by moving an icon representing the desired data object into the user interface (e.g., a window) provided by the basket control. With various examples of the invention, the basket control may also include a collection creation component, which creates an integrated collection of data items corresponding to the objects provided to the basket control. For example, the collection creation tool may create a collection of entire copies of the data objects. Alternately, the collection creation tool may create a collection of pointers pointing to the selected data objects.

With some implementations of the invention, the basket control may be instantiated by itself. For example, the basket control may be provided as a stand-alone tool on a desktop of an operating system or hosted by another software object. Alternately, with various implementations of the invention, the basket control may be used in conjunction with one or more other software objects to improve the basket tool's usefulness. For example, the basket tool may be hosted by a “listmaker” control that conveniently contains both the basket control and one or more user interfaces that a user can employ to provide data objects to the basket control.

More particularly, a listmaker control may include a viewing graphical user interface (such as a file browser) for viewing data objects and a navigation toolbar for navigating the viewing graphical user interface. This arrangement allows a user to select desired data objects with the viewing graphical user interface, and then add the selected data objects to a collection by submitting the selected data objects to the basket control. Like the basket control, a listmaker control incorporating a basket control may be provided by itself, or hosted as desired in a variety of software applications.

Operating Environment

Different embodiments of the invention may be implemented on a wide variety of computing devices. More particularly, a tool for creating integrated collections according to various examples of the invention may be implemented using computer-executable instructions, such as program modules, executed by one or more computing devices. Generally, program modules include routines, programs, objects, components, data structures, etc. that perform particular tasks or implement particular abstract data types. Typically, the functionality of the program modules may be combined or distributed as desired in various embodiments.

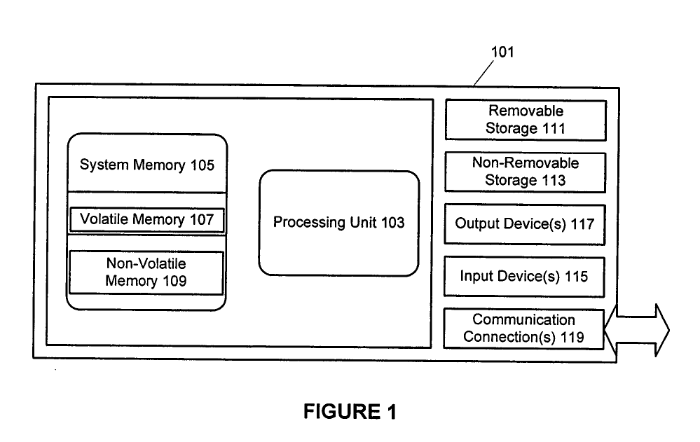

Because the invention may be implemented using software, it may be helpful for a better understanding of the invention to briefly discuss the components and operation of a typical, generalized programmable computer on which various embodiments of the invention may be employed. FIG. 1 illustrates an example of a computing device 101 that provides a suitable operating environment in which various embodiments of the invention may be implemented. This operating environment is only one example of a suitable operating environment, however, and is not intended to suggest any limitation as to the scope of use or functionality of the invention. Other well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing device 101 typically includes at least some form of computer readable media. Computer readable media can be any available media that can be accessed by the computing device 101. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, punched media, holographic storage, or any other medium which can be used to store the desired information and which can be accessed by the operating environment 101.

Communication media typically embodies computer readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

With reference to FIG. 1, in its most basic configuration the computing device 101 typically includes a processing unit 103 and system memory 105. Depending on the exact configuration and type of computing device 101, the system memory 105 may include volatile memory 107 (such as RAM), non-volatile memory 109 (such as ROM, flash memory, etc.), or some combination of the two memory types. Additionally, device 101 may also have mass storage devices, such as a removable storage device 111, a non-removable storage device 113, or some combination of two storage device types. The mass storage devices can be any device that can retrieve stored information, such as magnetic or optical disks or tape, punched media, or holographic storage. As will be appreciated by those of ordinary skill in the art, the system memory 105 and mass storage devices 111 and 113 are examples of computer storage media.

The device 101 will typically have one or more input devices 115 as well, such as a keyboard, microphone, scanner or pointing device, for receiving input from a user. The device 101 will typically also have one or more output devices 117 for outputting data to a user, such as a display, a speaker, printer or a tactile feedback device. Other components of the device 101 may include communication connections 119 to other devices, computers, networks, servers, etc. using either wired or wireless media. As will be appreciated by those of ordinary skill in the art, the communication connections 119 are examples of communication media. All of these devices and connections are well know in the art and thus will not be discussed at length here.

The Basket Control

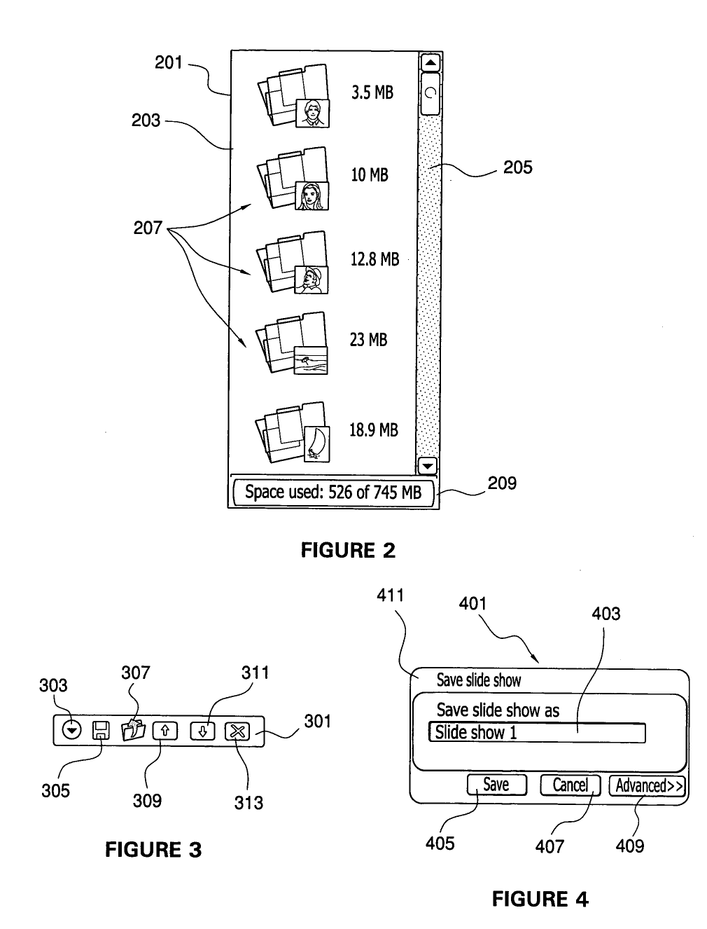

FIG. 2 illustrates one example of a basket control 201 according to various embodiments of the invention. As illustrated in this figure, the basket control 201 includes a basket display area 203. The basket display area 203 may be a windowed graphical user interface, such as those provided in the Microsoft Windows XP operating system. The basket display area 203 may include any desired navigational controls for navigating through the basket display area 203. For example, as shown in FIG. 2, the basket display area 203 may include a conventional vertical scroll bar 205 for vertically scrolling through the basket display area 203. Of course, various implementations of the basket display area 203 may alternately or additional include a horizontal scroll bar for horizontally scrolling through the basket display area 203.

As also shown in this figure, the basket display area 203 displays the representation of one or more data objects 207 to be included in an integrated collection. With the illustrated example, the data objects 207 are data files, but various implementations of the invention may display the representation of any data object to be included in an integrated collection, including, for example, a query or exclusion for identifying data files based upon designated criteria, and a virtual or physical folder, which may itself contain one or more data objects 207.

In the embodiment of the invention shown in FIG. 2, the basket display area 203 serves both as a basket interface for receiving data objects 203 and a display interface for displaying the data objects included in the collection. With alternate embodiments of the invention, however, the display interface may be separate from the basket interface, or omitted altogether. Also, while the embodiment of the invention illustrated in FIG. 2 displays all of the data objects included in the collection (using scrolling or other navigational techniques, as necessary), still other embodiments of the invention may only illustrate a portion of the data objects included in the collection, such as data objects of a specific type or only data objects that were submitted to the basket control 201.

With the example of the basket display area 203 shown in FIG. 2, each data object 207 is represented by an abstract image corresponding to the type of the data object 207, coupled with a “thumbnail” image (i.e., a small image of the data in the data object 207) and an alphanumerical indication of the size of the data object 207. It should be noted, however, that other embodiments of the invention may additionally or alternately include more or less information representing the data objects 207. Also, various embodiments of the basket control 201 may allow a user or hosting software application to select what type of information is used to represent the data objects 207. For example, some embodiments of the invention may allow a user or hosting software application to select whether the basket display area 203 will display a thumbnail image, a “tile,” an “icons,” the alphanumeric name of the data object 207, or the alphanumeric name of the data object 207 coupled with various details relating to the data object 207, such as its size, date of creation, date of last modification, etc.

Some embodiments of the basket control 201 may additionally include one or more status indicators, which may be used to show information regarding the integrated collection to be created from the data objects 207 represented in the basket display area 203. For example, in the illustrated embodiment, the status bar 209 shows an amount of storage space that would be occupied by the data objects 207 currently represented in the basket display area 203 relative to an amount of storage space associated with an integrated collection (such as, e.g., the amount of free storage space available on a compact disc onto which the collection can be saved). More particularly, the status bar 209 provides an alphanumeric indication of the amount of storage space that would be occupied by the data objects 207 relative to the total amount of storage space allocated for an integrated collection on a storage device. The status bar 209 also simultaneously provides a bar graph representation of the amount of storage space that would be occupied by the data objects 207 relative to the total amount of storage space allocated for an integrated collection. It should be appreciated, however, that still other embodiments of the invention may display additional or alternate information in the status bar 209, such as information relating to aggregations or accumulations of properties, like counts of items, total size, total duration, etc.

For example, with some embodiments of the invention, if the basket control 201 is used to form integrated collections from music files, then the status bar 209 may list the song titles corresponding to the data objects 207 in the basket control 201, and the total time (e.g., in the format Hours:Minutes:Seconds) required to listen to the data objects 207. Still further, various embodiments of the invention may include multiple status bars 209 to display any desired information relating to the data objects 207 represented in the basket display area 203. Moreover, with some embodiments of the invention, one or more of the status indicators may be selected for display by a user of the basket control 201 or, for example, a software developer providing the basket control 201 for a user, or hidden by the user or the software developer.

As noted above, the basket control 201 provides an interface that allows a user to select one or more data objects 207 to be included in an integrated collection. For example, with various implementations of the invention, a user may include any data object 207 in an integrated collection simply by submitting the desired data object 207 to the basket control 201. Thus, if the basket control 201 is implemented by an operating system that employs graphical user interfaces, such as the Microsoft Windows XP operating system, a user may add a data object 207 to an integrated collection simply by moving a graphical representation of the desired data object 207 into the basket display area 203.

More particularly, if the basket control 201 is implemented using the Microsoft Windows XP operating system, then the basket control 201 can be formed from the “Explorer view” software component (or a similar browser-type component used as an interface to both display and manipulate data objects). The basket control 201 may then include additional functionality to, for example, create copies of the submitted data objects 207 to be included in the collection, or shortcuts or pointers to the submitted data objects 207 to be included in the collection. This arrangement will allow users to submit a data object 207 to the basket control 201 by “dragging and dropping” a graphical user interface representation of the data object 207 (e.g., an icon) inside the basket display area 203 of the basket control 201 as conventionally known for other Microsoft Windows XP Explorer windows. Of course, any desired technique for submitting a data object 207 to the basket interface portion of the basket control 201, such as providing a command in a command menu associated with the data object 207 or using a “paste” edit command to submit a previously copied file may alternately or additionally be employed.

It should also be noted that, with various examples of the invention, the basket control 201 may alternately or additionally be used to edit an existing integrated collection. For example, a user may employ a command associated with an integrated collection to instantiate a basket control 201 containing the data objects 207 corresponding to that integrated collection. The user may then add one or more desired data objects 207 to the integrated collection by submitting the desired data objects 207 to the basket control 201, or rearrange the order of data objects 207 if permitted by the integrated collection.

With various embodiments of the invention, a user may employ the basket control 201 to exclude desired data objects 207 from an integrated collection by withdrawing the desired data objects 207 from the basket control 201. For example, if the basket control 201 is implemented by an operating system that employs graphical user interfaces, such as the Microsoft Windows XP operating system, a user may prevent a data object 207 from being included in an integrated collection simply by moving or deleting a graphical representation of the desired data object 207 from the basket display area 203. Further, with various examples of the invention, if the basket control 201 contains data objects 207 that are already included in an existing integrated collection, a user may delete one or more desired data objects 207 from the existing collection by removing or deleting the representation of each desired data object 207 from the basket control 201. Of course, any desired technique for withdrawing a data object 207 from the basket control 201, such as providing a command in a command menu associated with the data object 207, may alternately or additionally be employed.

For some embodiments of the invention, the data items in an integrated collection may be ordered according to predetermined criteria, such as, for example, alphabetical order of the names of the corresponding data objects 207 or the chronological order in which the corresponding data objects 207 were submitted to the basket control 201. With still other embodiments of the invention, however, the basket control 201 may be employed to control the ordering of data items in an integrated collection. More particularly, with various examples of the invention, a user may arrange the order of items in an integrated data collection that permits ordering by ordering the representation of the data objects 207 corresponding to the collection in the basket control 201. Further, still other examples of the invention may allow a user of the basket control 201 or, for example, a hosting software application, to select whether the order of the representation of the data objects 207 determines the ordering of data items in the corresponding integrated collection, or whether predetermined criteria determines the ordering of data items in the corresponding integrated collection. If an implementation of the invention does allows for the ordering data objects 207 as desired, it may include one or more functions to assist in the ordering of data objects 207. For example, the basket control 201 may provide the current order number next to the representation of each data object 207 in the basket display area 203.

Also, some types of data object collections may allow a user to create “active” integrated collections. Thus, various examples of the invention may allow a user to include data items corresponding to active data objects 207, such as queries or exclusions (sometimes collectively referred to as “virtual folders”), which select or exclude one or more data objects 207 from a group of data objects 207 based upon designated criteria. For example, a query virtual folder for music data files may include all music data files within a data structure that the user played the previous day (i.e., “The music I listened to yesterday”). Of course still other embodiments of the invention may prohibit the use of active data objects 207, and create integrated collections with data items corresponding to only “static” data objects 207. Alternately, with various embodiments of the invention, the basket control 201 may run the query or exclusion at the time a dynamic data object 207 is submitted, and add the results of the query or exclusion to the collection as flat data objects 207.

It should be noted that some types of data object collections may alternately or additionally allow a user to nest one or more data objects 207 within another data object 207, so as to form a multi-level hierarchy of data objects 207. Thus, various embodiments of the invention may allow a user to submit hierarchical data objects 207 to a collection. For example, a data object 207 submitted to the basket control 201 may be a “containing” data object 207 that may contain one or more other data objects 207, such as a folder or other collection. With these examples of the invention, a user may nest one or more data objects 207, such as data files, folders, or other collections within the containing folder in the basket control 201. Alternately, if a data object 207 already contains one or more other data objects 207, then a user may remove the one or more data objects 207 from the containing data object 207. Accordingly, if the basket control 201 includes a folder that contains one or more data files or other folders, then a user may remove these data files or other folders from the containing folder. The data objects 207 removed from a containing data object 207 may be withdrawn entirely from the basket control 201, or may simply be moved to another position within the basket control 201.

Of course, some types of collections may not permit the nesting of data objects 207. Thus, various embodiments of the invention may represent the data objects 207 submitted to the basket control 201 as “flat” and without a hierarchy. Moreover, even if a collection allows nested data objects 207, there may be some circumstances when a specific nesting of data objects 207 is not permitted. For example, if a data object 207 is a virtual folder corresponding to a query (i.e., an instruction to select files based upon designated criteria), then a user may be prohibited from nesting a data object 207 within that virtual folder that does not meet the designated criteria. With these examples (or where embodiments of the invention do not permit nesting of data objects 207), the basket control 201 may generate an error message if a user attempts to perform a prohibited nesting of data objects 207.

Additionally, some embodiments of the invention may allow a user to submit duplicate copies of a data object 207 to the basket control 201, while other embodiments of the invention may prohibit the inclusion of duplicate copies of a data object 207 in the basket control 201. With those embodiments of the invention that prohibit the inclusion of duplicate copies of data objects 207, the basket control 201 may create an error message when a user attempts to submit a data object 207 to the basket control 201 when the basket control 201 already includes a duplicate copy of that data object 207. Further, some embodiments of the invention may provide a menu command to remove duplicate copies of data objects 207 from a collection.

Still further, some embodiments of the invention may allow a user of the basket control 201 or, for example, a software developer providing the basket control 201 for a user, to select whether the basket control 201 will display data objects 207 as nested, or display the data objects 207 in a flat arrangement without a hierarchy. Some embodiments of the invention may also allow a user or a software developer to choose whether the basket control 201 will accept or prohibit active data objects 207, such as virtual folders, while still other embodiments of the invention allow a user or software developer to choose whether the basket control 201 will accept duplicate copies of a data object 207. Some embodiments of the invention may allow a user to select from among a combination of functional options for the basket control 201. For example, an embodiment of the invention may, by default, display the hierarchy of nested data objects 207 in an integrated collection, but convert all active data objects 207 to static data objects 207 before forming the integrated collection. The software application hosting the basket control 201 may be able to change this default setting, however, to have the basket control 201 prohibit nested data objects 207 and/or maintain active data objects 207.

Various examples of the basket control 201 may alternately or additionally include one or more navigation controls, such as navigation buttons contained in one or more toolbars. The navigation buttons may, for example, allow a user to view data objects 207 nested within other data objects (e.g., data files stored within folders), move up, down, left or right in the basket display area 203, or even delete data objects 207 from the basket control 201.

Because data objects 207 are submitted to the basket control 201 to form an integrated collection, the basket control 201 may also include a component for finalizing an integrated collection with the data objects 207 submitted to the basket control 201. For example, in addition to a status indicator and one or more navigation controls, the basket control 201 may additional include a command button for forming an integrated collection corresponding to the data objects 207 submitted to the basket control 201 (and thus represented in the basket display area 203). When a user is satisfied that the basket control 201 contains all of the data objects 207 that the user wishes to be included in an integrated collection, the user may cause an integrated collection including those data objects 207 to be created by activating the command button. It should be noted, however, that other command controls can alternately or additionally be employed to form an integrated collection from data objects 207 submitted to the basket control 201.

FIG. 3 illustrates an example of a basket toolbar 301 that can be included in a basket control 201 according to various embodiments of the invention. As seen in this figure, the basket toolbar 301 includes both navigation controls and a collection creation control. More particularly, the basket toolbar 301 contains a “more commands” command button 303 and an “up” command button 307. The “more commands” command button 303 allows a user to view additional command provided by the basket toolbar 301, while the “up” command button 307 then navigates up one level in the hierarchy of data objects 207 displayed in the basket display area 203. It should be noted, however, that the “up” command button 307 may be hidden, omitted or inactive if the basket control 201 has been configured to maintain flat data objects 207, or if the collection prohibits nesting. This button 307 may also be hidden, omitted or inactive if the basket display area 203 is already displaying the top level of their basket control 201 or if the basket control 201 is empty.

The basket toolbar 301 also includes a “move up” command button 309 and a “move down” command button 311, which moves selected data objects 207 up or down in the ordering of data objects 207 in the basket control 201, respectively. These command buttons 309 and 311 may be hidden, omitted or inactive if the basket control 201 has been configured not to allow ordering of its contained data objects 207. Also, these command buttons may be hidden, omitted or inactive if no data objects 207 have been selected. Also, if the top data object 207 displayed in the basket display area 203 has been selected, then the “move up” button 309 may be hidden, omitted or inactive. Similarly, if the last data object 207 displayed in the basket display area 203 is selected, then the “move down” button 311 may be hidden, omitted or inactive. Still further, the basket toolbar 301 includes a “delete” command button 313, which removes selected data objects 207 from the basket control 201.

In addition to these navigation controls, the basket toolbar 301 may also include a “save collection” command button 305, for creating a collection corresponding to the data objects 207 contained in the basket control 201. With various embodiments of the invention, a user interface may be presented to the user when the user activates this button, to assist the user in determining various properties of the collection being created. For example, some embodiments of the invention may present the user with the save collection dialog box 401 shown in FIG. 4. As seen in this figure, the save collection dialog box 401 includes a name control 403, into which a user may enter the desired name of the collection being created. If the save collection dialog box 401 is provided to save an edit of a previously existing collection, then the name of that previously existing collection may be displayed in the name control 403. If the save collection dialog box 401 is being used to create a new collection, then the name control 403 may be blank. Alternately, the name control 403 may initially display a default name, such as “Collection [n]” where n is a number.

The save collection dialog box 401 also includes a “save” button 405, for actually creating a collection having the name provided in the name control 403 and including data items corresponding to the data objects 207 contained in the basket control 201, and a “cancel” button 407, for canceling the process of creating the integrated collection. The save collection dialog box 401 may also include an “advanced button” 409, which may provide additional controls for determining the properties or other values related to the integrated collection being created.

It should be noted that, with various embodiments of the invention, different aspects of the user interface may be configured by a software application hosting the basket control 201. For example, with the save collection dialog box 401 illustrated in FIG. 4, the title 411 of the save collection dialog box 401 can be designated by the software application hosting the basket control 201. Thus, if the hosting software application relates to playback of music files, the title 411 of the save collection dialog box 401 may read “Save playlist.” On the other hand, if the hosting software application relates to the display of image files, then the title 411 of the save collection dialog box 401 may read “Save slide show,” as shown in this figure. Similarly, text above the textbox in the save collection dialog box 401 and other text inside of the text box may be configured as desired by the software application. Further, the file format of the collection being created may be determined by the software application hosting the basket control 201. Thus, a hosting software application that relates to the playback of music files may save the integrated collection with a .wpl (Windows Play List) file format. If the hosting application does not designate a specific file format for the collection being created, then it may be assigned a default file format, such as a file format for a static list type of collection.

Further, the “save collection” command button 305 itself may be modified, hidden, omitted or rendered inactive by the software application. For example, the “save collection” command button 305 may be configured to display desired text. Thus, a hosting software application that relates to the playback of music may modify the “save collection” command button 305 to include the text “Save Playlist,” while a hosting software application that relates to the display of images may modify the “save collection” command button 305 to include the text “Save Slideshow.” Still further, the software application hosting the basket control 201 may omit the “save collection” command button 305 altogether. For example, as will be discussed in more detail below, the hosting software application may provide its own command controls for creating an integrated collection corresponding to the data objects 207 contained in the basket control 201.

As previously noted, for various embodiments of the invention the basket control 201 may be implemented using conventional software techniques or components, such as the “Explorer view” software component provided in the Microsoft Windows XP Explorer software application. Conveniently, the basket control 201 may include some or all of the features of the Explorer view software component. For example, with some implementations of the invention, a user may be able to “double click” on a containing data object 207 (i.e., select the containing data object 207 and activate a command key, such as a key on a pointing device, twice) to navigate within the containing data object 207. Alternately or additionally, a user may be able to double-click on a file data object 207 to launch the software application that handles that type of file by default, in order to manipulate the file data object 207.

Further, a user may be able to “right-click” on a data object 207 (i.e., select the data object 207 and activate a different command key) to view a menu of commands for taking some action with respect to the selected data object 207. The menu may include conventional commands, such as “open,” “print,” “send to,” “cut,” “copy,” “delete,” “rename” and “[view] properties.” It should be noted, however, that in addition to or instead of the “delete” command, the menu provided for the data objects 207 may include a command to remove or withdraw the selected data object 207 from the basket control 201, as discussed in detail above. Still further, many embodiments of the invention may allow a user to change the view of the representation of the data objects 207 in the basket display area 203. For example, a user may be able to change the displayed view from icons for each data object 207 to an alphanumeric listing of each data object 207.

With some embodiments of the invention, the basket control 201 will not contain any data objects 207 when initially instantiated. In other embodiments of the invention, the basket control 201 may contain data objects 207 associated with the basket control 201 when it is initially instantiated. For example, as noted above, if the basket control 201 is associated with an existing integrated collection, then the basket control 201 may initially include the data objects 207 associated with the data items in the integrated collection.

Also, if the basket control 201 is launched from a software application in which data objects 207 previously have been selected, then the basket control 201 may initially include those selected data objects 207.

The Listmaker Control

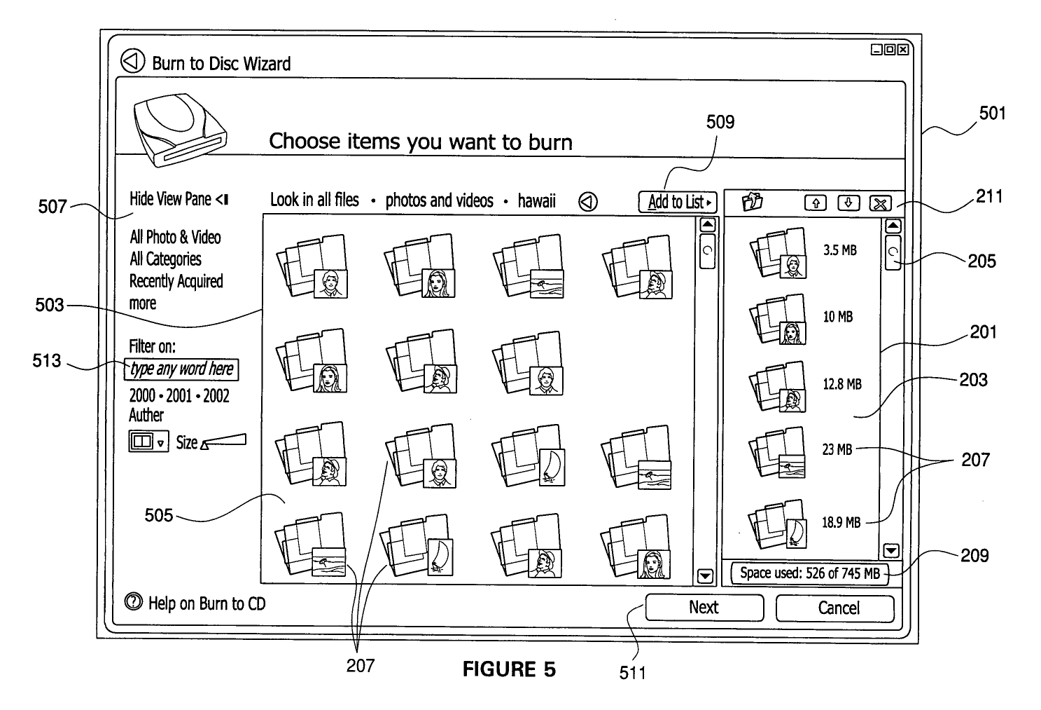

While the basket control 201 by itself provides a great deal of functionality, various embodiments of the invention may increase the usefulness of the basket control 201 by coupling it with other software applications or functionality. For example, as previously noted, some implementations of the invention may incorporate the basket control 201 into a listmaker control 501, as illustrated in FIG. 5.

As seen in this figure, the listmaker control 501 contains the basket control 201, including the basket display area 203, the vertical scroll bar 205, and the status bar 209, and a basket navigation toolbar 211 that includes navigational controls for navigating in the basket control 201, as described above. The listmaker control 501 also includes a navigational tool 503 for navigating to desired data objects 207. While the navigational tool 503 may be implemented using any desired type of navigational tool 503, various examples of the invention may implement the navigational tool 503 using a software application with graphical user interfaces, such as a browser application.

For example, in the embodiments of the invention illustrated in FIG. 5, the navigational tool 503 is implemented using the “Explorer view” component from the Explorer software application provided by the Microsoft Windows XP operating system. As seen in this figure, the navigational tool 503 employs several graphical user interfaces, including a navigational display area 505, a listmaker navigational toolbar 507, and a basket command toolbar 509. The navigational tool 503 provides these graphical user interfaces to assist a user in navigating to and identifying desired data objects 207, which are then graphically represented in the navigational display area 505. For example, the navigational tool 503 may include one or more navigational controls for navigating through a file structure, such as a list of available locations to be navigated and a control for selecting the type of data objects 207 (e.g., photograph files) to be displayed in the navigational display area 505.

The basket command toolbar 509 may then include one or more command controls for submitting data objects 207 identified by the navigational tool 503 to the basket control 201. In the illustrated example, the basket command toolbar 509 includes a command “Add to list.” Thus, after the user has selected one or more data objects 207 represented in the navigational display area 505 (using, for example, a pointing device such as a mouse or touchpad), the user can activate the command “Add to list” in order to submit the selected data objects 207 to the basket control 201.

Of course, in addition to (or instead of) commands provided in the basket command toolbar 509, various embodiments of the invention may allow a user to employ other techniques for submitting one or more data objects 207 identified by the navigational tool 503 to the basket control 201. For example, as previously noted, with some embodiments of the invention a user may “drag and drop” the representation of a data object 207 displayed in the navigational display area 505 to the basket display area 203 in order to submit that data object 207 to the basket control 201. With some embodiments of the invention, the representation of data objects 207 that have already been submitted to the basket control 201 may be highlighted or otherwise distinguished in the navigational display area 505.

In the embodiment of the invention illustrated in FIG. 5, the software application hosting the listview control 501 also provides a collection creation toolbar 511, for creating a collection corresponding to the data objects 207 submitted to the basket control 201. The collection creation toolbar 511 may include one or more command controls for creating an integrated collection from the data objects 207 contained in the basket control 201. In the illustrated example, the listmaker control 501 is hosted by a software application “wizard” for burning data objects 207 to an optical storage disc, such as a DVD or CD. Accordingly, the collection creation toolbar 511 includes the commands “Next” and “Cancel” for creating an integrated collection (or canceling the process of creating an integrated collection) by proceeding through the components of the wizard. Other embodiments of the invention, however, may provide command controls, such as command buttons, for expressly creating an integrated collection from the data objects 207 contained in the basket control 201 or in the listmaker control 501. Also, it should be noted that, while the illustrated embodiment of the invention includes a collection creation toolbar 511 with command controls for creating an integrated collection, other embodiments of the invention may additionally or alternately include the collection creation toolbar 511 in the basket control 201, as previously explained, or in the listmaker control 201.

As noted above, the navigational tool 503 may be implemented using conventional software application components and functionality, such as the “Explorer view” component provided in, for example, the Microsoft Windows XP operating system Explorer software application. Accordingly, the navigational tool 503 may include some or all of the features of the Explorer view software component. For example, with some implementations of the invention, a user may be able to double click on a containing data object 207 to navigate within the containing data object 207, and alternately or additionally double-click on a file data object 207 to launch the software application that handles that type of file by default, in order to manipulate the file data object 207.

Further, a user may be able to right-click on the representation of a data object 207 in the navigational display area 505 to view a menu of commands for taking some action with respect to the selected data object 207. The menu may include conventional commands, such as “open,” “print,” “send to,” “cut,” “copy,” “delete,” “rename” and “[view] properties.” It should be noted, however, that the menu provided for the data objects 207 may additionally include a command to submit the selected data object 207 to the basket control 201.

Still further, many embodiments of the invention may allow a user to change the view of the representation of the data objects 207 in the basket display area 203. For example, a user may be able to change the displayed view from an icon for each data object 207 to an alphanumeric listing of each data object 207. Also, various embodiments of the invention may allow a user to employ more sophisticated navigational tools, such as the view pane 513 illustrated in FIG. 5. The view pane 513 may be similar or identical to the view pane conventionally provided by the Microsoft Windows XP operating system Explorer view software component. Also, with some embodiments of the invention, the representations of data objects 207 in the navigational display area 505 may be highlighted, shown in a given color, or otherwise distinguished if those data objects 207 already are represented by the basket control. This easily identifies the data objects 207 in the navigational display 5050 that have been submitted to the basket control 201.

Moreover, with various embodiments of the invention, different features, properties and settings of the listmaker control 501 may be configured by a user or by a software application hosting the listmaker control 501 (i.e., by the software developer for the hosting software application). For example, the listmaker control 501 can be configured to open to a default starting location. Thus, if the hosting application is a software application related to the playback of music files, the application can designate that the navigational display area 505 initially display the representation of data objects 207 located in a portion of a data structure relating to music files, such as the “My Music” folder provided by the Microsoft Windows XP operating system. Similarly, if the hosting application is a software application related to the display of photographic images, the application can designate that the navigational display area 505 initially display the representation of data objects 207 located in a portion of a data structure relating to image files, such as the “My Pictures” folder provided by the Microsoft Windows XP operating system. If the software application has not designated a specific opening location for the listmaker control 501, then the listmaker control 501 may open to the last location accessed by the hosting software application or to a default location (such as the “My Documents” folder provided by the Microsoft Windows XP operating system).

The software application hosting the listmaker control 501 may also specify the file types that will be represented in the navigational display area 505 (and thus available to be submitted to the control basket 201). For example, if the hosting application is a software application related to the playback of music files, the application can designate that the navigational display area 505 initially display the representation of only data objects 207 having a music file type (e.g., .mp3 or .wma files). Similarly, if the hosting application is a software application related to the display of photographic images, the application can designate that the navigational display area 505 initially display only the representation of data objects 207 with an image file type, such as .tif and .jpg. file types.

Further, with some embodiments of the invention, a software application hosting the listmaker control 501 may specify the view provide by the navigational display area 505. The hosting software application may also specify whether the view pane will be initially displayed or hidden.

Accordingly, the listmaker control 501 provides software applications with a powerful tool for assisting a user in creating integrated collections. Further, while the listmaker control 501 may incorporate all of the functionality of the basket control 201, it advantageously allows a hosting software application to provide users with additional functionality for creating integrated collections. Moreover, this additional functionality can be configured by the software application to better correspond with the functionality and purpose of the hosting software application itself.

Interfaces for the Basket Control and the Listmaker Control

According to various examples of the invention, the basket control 201, the listmaker control 501, or both may be implemented as software objects that can conveniently be hosting by a software application simply by accessing an interface for the software object. This type of interface, sometimes referred to as a “application programming interface,” allows a software application to both host the listmaker control 501 (or the basket control 201) and designate specific settings for the listmaker control 501 (or the basket control 201), without having to incorporate all of the software instructions required to implement the listmaker control 501 or the basket control 201.

A hosting application may thus employ an application programming interface that creates a collection. This application programming interface may, for example, include functionality to manage an ordered collection or list, such as functionality to insert an item (e.g., a data object 207) into the list, remove and item from the list, and get an item in the list. It may also include functionality to manage a container of links (e.g., pointers or “shortcuts” to the data objects 207 in the list).

Various examples of the invention may also provide an application programming interface that includes software instructions to create specialized types of collections, such as a playlist folder. This application programming interface, referred to hereafter as a “playlist” application programming interface, may employ the basic ordered collection application programming interface described above, but provide additional functionality to a collection. For example, a specialized collection application programming interface may provide a basic ordered collection with a “copy mode” property, which determines how data objects 207 will be copied into the collection. If the value of the property is “flat,” then the contents of nested data objects 207 will be flattened out when added to the collection. If, however, the value of the property is “not flat,” data objects 207 will retain their nested hierarchy when added to the collection. The value of the “copy mode” property may thus be specified by the hosting application to correspond to the use of the collection. Thus, a generic collection and a collection containing music files may have the “copy mode” property set to “flat,” while a collection for photographic images may have the copy mode set to “not flat.”

The playlist application programming interface may also provide a collection with a “web theme” property. This property determines, for example, background images that are displayed by the listmaker control 501 when accessing the collection. Thus, a generic collection may have a generic “web theme” property value of “list,” while a collection for music files may have a “web theme” property value of “playlist” (which may, e.g., instruct the listmaker control 501 to display music notes or instruments as background images). Similarly, while a collection for music files may have a “web theme” property value of “photo_album” (which may, e.g., instruct the listmaker control 501 to display a camera or a photo_album as background images). The playlist application programming interface may also provide a collection with a “perceived folder type” property, which determines how images representing folder data objects 207 are displayed.

The playlist application programming interface may also provide a collection with a “default columns” property, which defines the information displayed for a data object 207. For example, if the “default column” value may be set to “Name;Order;Artist;Album;Duration” for a collection of music files. When information for a data object 207 in the collection is then displayed, it will include the song name associated with the data object 207, the order of the data object 207 in the collection, the name of the artist associated with the data object 207, the name of the music album associated with the data object 207, and the duration of the music associated with the data object 207. On the other hand, the “default column” value may be set to “Name;Order” for a generic collection, so that only the name of each data object 207 and its order in the collection are displayed. Still further, the playlist application programming interface may provide a collection with an “order” property, which determines whether this collection will update its ordering of data objects 207 when a new data object 207 is added to or removed from the collection.

Various examples of the invention may also provide a basket control application programming interface that creates the basket control. This application programming interface will create a basket control object, which may be, for example, a simple browser software component. The basket control application programming interface may then provide for various properties, methods, and notifications associated with the basket control. For example, the basket control application programming interface may include the property “RootFolder”, which may be readable and writable before the basket control is displayed. This property identifies the collection for which the basket control is created. If the value of this property is “null,” the basket control may create a temporary collection.

The basket control application programming interface may also include properties relating to how the data objects 207 in a collection and the information relating to the data objects 207 are displayed by the basket control. For example, the basket control application programming interface may include a property “flags,” which may be readable and writable before the basket control is displayed. This property defines various flags associated with the basket control. The value of this property may include, for example, “hidenavigation,” which hides the navigation buttons and commands, even if the collection supports them, “widelayout,” which causes the toolbar (or toolbars) to be left-aligned, hides the header, and provides additional space on the status bar for additional controls. This property may also have the value “hideorder,” which hides the ordering buttons and commands, even if the collection supports ordering.

The basket control application programming interface may also include the properties “VisibleColumns” and “ViewFlags,” both of which may be readable and writable. The “VisibleColumns” property defines what columns are displayed for the representation of a data object 207 in the basket display area 203, while the property “ViewFlags” property defines what flag are displayed for the representation of a data object 207 in the basket display area 203. The basket control application programming interface may also include a “ViewMode” property, which may be readable and writable. The “ViewMode” property determines the mode (e.g., icons, details, thumbnails), etc. for which the representation of data objects 207 in the collection will be displayed. Further, the basket control application programming interface may have a “Header,” property, which may be readable and writable, and which designates a header to be displayed in the basket control. Additionally, the basket control application programming interface may include a “WatermarkText” property, which may be readable and writable before the basket control is displayed, that determines text to be displayed when the basket display area 203 is empty.

The basket control application programming interface may also include one or more properties relating to the operation of the status bar. For example, the basket control application programming interface may include a property “StatusProperties,” which may be readable and writable before the basket control is displayed, and which defines the properties of the collection to be displayed (or the aggregations of which are to be displayed) by the status bar. The basket control application programming interface may also include the property “StatusText,” which may be both readable and writable, and which replaces the display of properties in the status bar with a string of text. If the value of this property is set to “null,” then the properties reappear in the status bar.

In addition, the basket control application programming interface may include one or more methods associated with the status bar. For example, the basket control application programming interface may include the method “SetStatusGauge(int isp, object maximum, string format),” which activates a gauge display, (e.g., a three-dimensional pie chart) for the associated property at the given index. The hosting application may use this method to activate a gauge display for one of the properties of the status bar. For example, the gauge display may be a three-dimensional pie chart that displays a pie slice proportional to the current aggregated value of the property, relative to the maximum value specified by the hosting application. Further, the hosting application may specify a string (e.g., a text string), which the basket control may use to format a textual description of the property, with tokens that are replaced by the property's current total and the maximum value. For example, the status bar may display the text “45 MB used out of 600 MB available.”

The basket control application programming interface may also include one or more notifications, for notifying other software components of events. For example, the basket control application programming interface may include the notification “FolderContentsChanged,” which sends an event message when the contents of the collection are modified.

Additionally, various embodiments of the invention may provide a listmaker application programming interface for creating a listmaker control. The listmaker control may be implemented from, for example, a simple browser software component and the basket control created by the basket control application programming interface. Thus, the listmaker control application programming interface may include various properties relating to the browser component or the basket control. For example, the listmaker control application programming interface may include a property “FolderView,” which may be a read-only value that identifies the browser component employed by the listmaker control. Similarly, the listmaker control application programming interface may include a property “Basket,” which may be a read-only value that identifies the basket control employed by the listmaker control. Further, the listmaker control application programming interface may include a property “BasketWidth,” which may be a readable and writable value that specifies the width of the basket control within the listmaker control.

It should be noted that, while examples of various programming application interfaces have been described above, any of these application programming interfaces may employ additional or alternate properties, methods, and notifications, depending upon the functionality desired and the operating system environment in which the application programming interfaces will be used.

### Conclusion

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. A tool for creating an integrated collection, comprising:
a basket interface that receives data objects to be manipulated simultaneously; and
a collection creation component that, for each data object submitted to the basket interface, adds at least one data item corresponding to the submitted data object to a collection of data items.

2. The tool recited in claim 1, wherein the basket control includes a display interface that displays representations of the data objects received by the basket interface.

3. The tool recited in claim 2, wherein the display interface displays representations of all data objects corresponding to a data item in the collection.

4. The tool recited in claim 2, wherein the basket interface and the display interface share a single graphic user interface.

5. The tool recited in claim 2, wherein
the display interface allows a user to specify an order for the data objects received by the basket interface; and
the collection creation component adds data items to the collection according to the order of the data objects specified by the user.

6. The tool recited in claim 2, further comprising one or more navigation controls for navigating among the data objects represented by the display interface.

7. The tool recited in claim 1, wherein the collection includes pointers pointing to the data objects received by the basket interface.

8. The tool recited in claim 1, wherein the collection creation component creates a new collection upon instantiation.

9. The tool recited in claim 1, wherein
the basket interface allows data objects to be removed from the basket interface; and
for each data object removed from the basket interface, the collection creation component removes each data item corresponding to the removed data object from the collection.

10. The tool recited in claim 1, further including a name control that facilitates naming of the collection.

11. The tool recited in claim 1, further comprising a notification component that notifies other software applications when the collection of data items changes.

12. The tool recited in claim 1, further comprising a status display for displaying information related to the data objects submitted to the basket interface.

13. The tool recited in claim 12, wherein the status display displays an amount of storage that would be occupied by the data objects submitted to the basket interface.

14. The tool recited in claim 12, wherein the status display displays an amount of storage associated with the collection.

15. The tool recited in claim 12, wherein the status display displays a relationship between an amount of storage that would be occupied by the data objects submitted to the basket interface and an amount of storage associated with the collection.

16. The tool recited in claim 1, further comprising:
a listmaker control that provides data objects which may be submitted to the basket interface.

17. The tool recited in claim 16, wherein the listmaker control includes a second display interface for displaying a representation of data objects that may be submitted to the basket interface.

18. The tool recited in claim 17, wherein the listmaker control includes one or more second navigation controls for navigating among one or more data objects for representation by the second display.

19. The tool recited in claim 16, wherein the listmaker control includes a data object submission control that, when activated, submits selected data objects represented in the second display to the basket interface.

20. The tool recited in claim 16, wherein the listmaker control includes a menu component that provides a menu of commands associated with selected data objects, such that the menu includes at least one command to submit the selected data objects to the basket interface.

21. A method of providing an integrated list of data items corresponding to data objects, comprising:
receiving one or more data objects; and
for each received data object, adding at least one data item corresponding to the received data object to a list of data items.

22. The method recited in claim 21, further comprising displaying a representation of the received data objects.

23. The method recited in claim 22, further comprising displaying each data object corresponding to a data item in the list.

24. The method recited in claim 22, further comprising providing navigation controls for navigating among the displayed representation of the received data objects.

25. The method recited in claim 21, further comprising receiving instructions for ordering data items in the list.

26. The method recited in claim 21, further comprising creating the list.

27. The method recited in claim 21, further comprising:
receiving instructions to withdraw one or more data objects; and
for each withdrawn data object, deleting every data item corresponding to the withdrawn data object from the list.

28. The method recited in claim 21, further comprising:
receiving a name for the list; and
naming the list with the received name.

29. The method recited in claim 21, further comprising notifying other software applications of a change in the list.

30. The method recited in claim 21, further comprising displaying information relating to a status of the list.

31. The method recited in claim 30, wherein the displayed information is an amount of storage occupied by the received data objects.

32. The method recited in claim 30, wherein the displayed information is an amount of storage associated with the list.

33. The method recited in claim 30, wherein the displayed information is an amount of storage an amount of storage that would be occupied by the received data objects relative to an amount of storage associated with the list.

34. The method recited in claim 21, further comprising:
receiving the data objects through a basket interface; and
displaying a representation of data objects that may be received through the basket interface.

35. The method recited in claim 34, further comprising providing one or more navigation controls for navigating among the displayed representation of data objects that may be received through the basket interface.

36. The method recited in claim 34, further comprising providing a submission control that, when activated, submits selected data objects among the displayed representation of data objects that may be received through the basket interface.

37. The method recited in claim 34, further comprising providing a menu of commands for selected data objects among the displayed representation of data objects that may be received through the basket interface, such that the menu of command includes a command to submit the selected data objects to the basket interface.

38. A method for providing an interface to a list of data items, comprising:
receiving a list parameter identifying a list of data items; and
in response, causing a control to be created that receives data objects and, for each received data object, adds at least one data item to the identified list that corresponds to the received data object.

39. The method recited in claim 38, wherein the control provides a graphical user interface displaying representations of data objects corresponding to data items in the list.

40. The method recited in claim 39, further comprising
receiving one or more flag parameters for determining content of the graphical user interface for the control; and
in response, causing the control to include content in the graphical user interface corresponding to the received flag parameters.

41. The method recited in claim 40, further comprising
causing the control to display the graphical user interface without navigation controls for navigating among the displayed representations of the data objects corresponding to data items in the list.

42. The method recited in claim 40, further comprising:
causing the control to display the graphical user interface without ordering controls for ordering the displayed representations of the data objects corresponding to data items in the list.

43. The method recited in claim 38, further comprising:
receiving property parameters; and
in response, causing the control to display properties corresponding to the received property parameters.

44. The method recited in claim 43, wherein the properties include properties of the received data objects.

45. The method recited in claim 43, wherein the properties include properties of the list.

46. The method recited in claim 38, further comprising:
receiving instructions to activate a status functionality; and
in response, causing the control to activate the status functionality.

47. The method recited in claim 38, wherein the list parameter has a null value, and in response, causing the control to create a new list of data items.

48. The method recited in claim 38, further comprising notifying another software application when the list changes.
